(19) United States
(12) Patent Application Publication
(10) Pub. No.: US 2026/0093157 A1
(43) Pub. Date: Apr. 2, 2026

(54) ACCESSORY DEVICES FOR FACILITATING IMAGE CAPTURING BY AN ELECTRONIC DEVICE

(71) Applicant: Apple Inc., Cupertino, CA (US)

(72) Inventors: Holly GERHARD, Los Altos, CA (US); Cierra A. JAGAN, Cupertino, CA (US); John S. CAMP, Los Gatos, CA (US)

(21) Appl. No.: 19/013,994

(22) Filed: Jan. 8, 2025

Related U.S. Application Data
(60) Provisional application No. 63/701,933, filed on Oct. 1, 2024.

(51) Int. Cl. G03B 7/30; G06F 3/02; H04N 23/60

(52) U.S. Cl. CPC G03B 7/30; G06F 3/02; H04N 23/60

(57) ABSTRACT

An accessory device functions to enhance image capturing events by an electronic device. The accessory device may include a button that is positioned to provide relative ease for depressing whether the electronic device, including a camera, is in a portrait mode or a landscape mode. The button of the accessory device may be offset with respect to a button of the electronic device. However, the button of the accessory device may nonetheless provide an input (e.g., actuation, touch input, force sensing) to the button of the electronic device. Some accessory devices include a stand that allows for rotation of a receptacle of an accessory device, thus facilitating capturing a panoramic image by the electronic device. Also, some buttons may take the form of lockable buttons.

### CROSS REFERENCE TO RELATED APPLICATION(S)

The present application claims the benefit of U.S. Provisional Application No. 63/701,933, entitled “ACCESSORY DEVICES FOR FACILITATING IMAGE CAPTURING BY AN ELECTRONIC DEVICE”, filed Oct. 1, 2024, the entirety of which is incorporated herein for reference.

### TECHNICAL FIELD

This application is directed to accessory devices, and more particularly, to accessory devices that enhance image and/or video capturing events by electronic devices.

### BACKGROUND

Electronic devices include certain physical features (e.g., buttons) used for applications, such as image capturing applications. Image capturing applications utilize one or more cameras of an electronic device. Further, the camera of an electronic device may be oriented to capture images in a portrait mode, and by rotating the electronic device the camera may be oriented to capture images in a landscape mode. Based on the orientation of the electronic device for portrait or landscape mode, the button of the electronic device utilized to capture images may appear in different locations to the user of the electronic device.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a plan view of an embodiment of an accessory device, in accordance with aspects of the present disclosure.

FIG. 2 illustrates a plan view of an accessory device, further showing an electronic device positioned within the accessory device, in accordance with aspects of the present disclosure.

FIG. 3 illustrates a partial cross-sectional view of an accessory device and an electronic device, showing further details of the accessory device, in accordance with aspects of the present disclosure.

FIG. 4A and FIG. 4B illustrate side views of an accessory device and an electronic device, showing different orientations of the accessory device and the electronic device, in accordance with aspects of the present disclosure.

FIG. 5A and FIG. 5B illustrate an alternate embodiment of an accessory device, showing the accessory device with a stand, in accordance with aspects of the present disclosure.

FIG. 6 illustrates an aerial view of the accessory device and the electronic device shown in FIG. 5A and FIG. 5B, showing exemplary movement of the accessory device and the electronic device, in accordance with aspects of the present disclosure.

FIG. 7A and FIG. 7B illustrate aerial views of accessory device carrying electronic device for rotational movement of electronic device, in accordance with aspects of the present disclosure.

FIGS. 8A and 8B illustrate side views of an alternate embodiment of an accessory device for an electronic device, in accordance with aspects of the present disclosure.

FIG. 9 illustrates a side view of an alternate embodiment of an accessory device, showing a button of the accessory device capable of being locked and unlocked, in accordance with aspects of the present disclosure.

FIG. 10A and FIG. 10B illustrate side views of an alternate accessory device, showing exemplary movement of a button of the accessory device, in accordance with aspects of the present disclosure.

FIG. 11, FIG. 12, FIG. 13, and FIG. 14 illustrate various views of an alternate embodiment of an accessory device, showing a button of the accessory device capable of being locked and unlocked by a slider mechanism, in accordance with aspects of the present disclosure.

FIGS. 15 and 16 illustrate aerial views of an alternate embodiment of an accessory device, showing a button of the accessory device capable of being locked and unlocked by alternate form of a slider mechanism, in accordance with aspects of the present disclosure.

FIG. 17 illustrates a rear view of an alternate embodiment of an accessory device, showing various components and features for the accessory device, in accordance with aspects of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to accessory devices with a button, or protruding feature, designed to facilitate image capturing events for electronic devices. When an electronic device is positioned (e.g., disposed) in an accessory device described herein, the button of the accessory device may protrude and function like a shutter button during an image capturing event by the electronic device. For example, when actuated, the button of the accessory device may cause an actuation of (or otherwise some form of an input to) a button of the electronic device, thereby initiating an image capturing event by a camera(s) of the electronic device. In some instances, the button of the electronic device utilized to capture images is flush, or sub-flush, with respect to a wall (e.g., sidewall) that surrounds the button. Beneficially, the button of the accessory device protrudes from a wall of the accessory device, making the button discernible to users and easier to press, thus enabling a quicker and more steady shutter button experience.

Buttons of the accessory devices may be located along an accessory device wall in a location corresponding to the location of an electronic device button along a wall of the electronic device. In this regard, the button of the accessory device may align with the button of the electronic device. However, in some exemplary embodiments, accessory devices described herein include a button that is offset, or not aligned. In these embodiments, the accessory device may include a lever, or levers, such that when the accessory device button is actuated, the lever(s) is/are actuated, resulting in an actuation of the electronic device button. The lever would beneficially also transfer forces onto a force sensing element (e.g., sensor, touch surface) on the electronic device's button, so that other operations that result from forces applied, that, for example, do not fully actuate the button, may be triggered through the user applying force to the button of the accessory device. The accessory device button can be relocated to a position that is easier and/or more ergonomic for users to depress, including when the electronic device camera is oriented in portrait or landscape mode, or any other orientation the user chooses to use for image capturing. Beneficially, the button may be positioned at a more optimal location for users. Additionally, a user may orient the camera to any other angle besides landscape or portrait, and the button location could be adjusted to another location that best accommodates the user's desired angle.

Additionally or alternatively, accessory devices described here include a button designed to, when depressed or touched by a user, alter a capacitive signal at a surface of the electronic device button. In this regard, an electronic device may respond to not only actuation but also a change in capacitance, with the actuation and capacitance change initiating a function (e.g., image capturing function) of the electronic device. Accessory devices described herein may cause a change in capacitance based on detection by for example, a touch sensor (e.g., capacitive touch sensor). An electronic device may detect a capacitance change that is detectable at the electronic device button (e.g., by a touch sensor or capacitive sensor integrated with the button). Accordingly, accessory devices described herein may actuate an electronic device button and/or provide a capacitance change at the electronic device button, with actuation and capacitance change initiating a function, or functions, of the electronic device.

Accessory devices described herein may be equipped (e.g., permanently equipped, detachable) with components, such as a power source (e.g., battery), a memory device, a lens, a stand, a mount, a glare shield, or a combination thereof. Any one or more of the aforementioned components allows an accessory device to provide enhanced image capturing by an electronic device. Moreover, given the features and functions, accessory devices described herein may function as camera-ready cases or camera-specific cases that are designed for utilization when users determine a camera(s) for an electronic device will be used for a specific event or duration. Additionally, accessory device buttons described herein may include dedicated function/programmable function buttons. For example, an accessory device may include one or more mechanical buttons, which, when pressed, conveys a signal to the electronic device. The electronic device may use the signal to, for example, to toggle on or off flash.

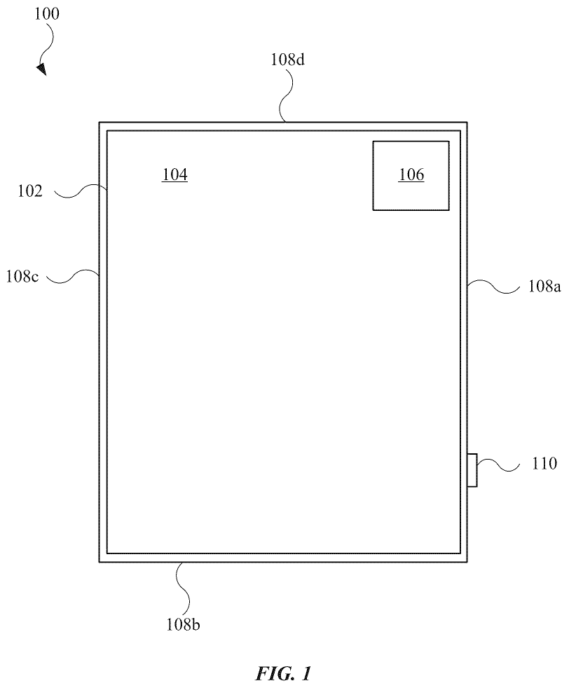

These and other embodiments are discussed below with reference to FIGS. 1-17. However, those skilled in the art will readily appreciate that the detailed description given herein with respect to these Figures is for explanatory purposes only and should not be construed as limiting.

FIG. 1 illustrates a plan view of an embodiment of an accessory device 100, in accordance with aspects of the present disclosure. Accessory device 100 is designed to carry electronic devices, including mobile wireless communication devices (e.g., smartphones, tablet computing devices). Accessory device 100 may include several walls used to form a receptacle 102 that provides a volume to receive an electronic device (not shown in FIG. 1). For example, accessory device 100 may include a wall 104 (e.g., bottom wall). Wall 104 may include an opening 106, or aperture, positioned to align with a camera assembly (not shown in FIG. 1) of an electronic device. Accessory device 100 may include additional walls. For example, accessory device 100 may include a wall 108a, a wall 108b, a wall 108c, and a wall 108d. Each of walls 108a, 108b, 108c, and 108d may be characterized as a sidewall. Also, each of the walls 104, 108a, 108b, 108c, and 108d define in part receptacle 102.

Additionally, accessory device 100 may include a button 110 (representative of one or more buttons on any one of the walls 108a, 108b, 108c, and 108d). When an electronic device is positioned in receptacle 102, button 110 may be used (e.g., depressed, touched, or a combination thereof) to provide an input to a button (e.g., electronic device button) of the electronic device.

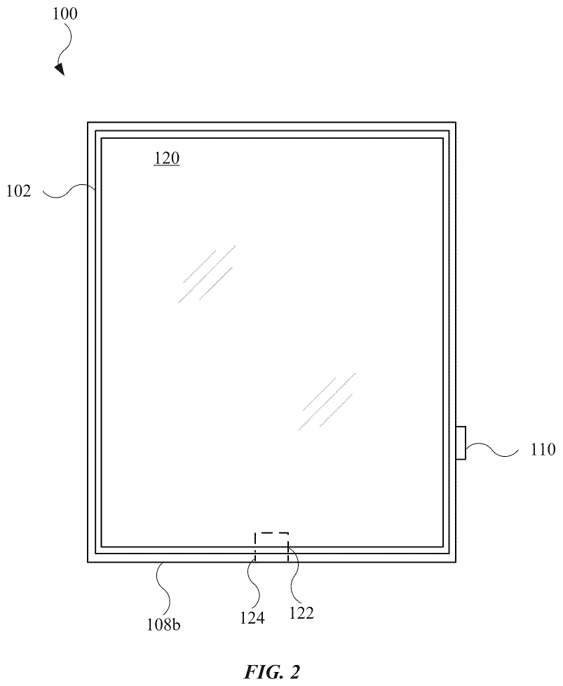

FIG. 2 illustrates a plan view of accessory device 100, further showing an electronic device 120 positioned within accessory device 100, in accordance with aspects of the present disclosure. Electronic device 120 may be positioned on receptacle 102 (shown in FIG. 1). In one or more implementations, button 110 is aligned with a button of electronic device 120.

Conversely, in one or more implementations, button 110 is offset, or not aligned with respect to the button of electronic device 120. This will be shown below. In either event, button 110 is nonetheless capable of providing input to electronic device 120 by way of interaction with the button of electronic device 120.

Also, electronic device 120 may further include a port 122. Port 122 is designed to receive a cable/connector (not shown in FIG. 2). In this regard, port 122 may allow for charging of a battery (not shown in FIG. 2) of electronic device 120 and/or data transfer between electronic device 120 and another device (not shown in FIG. 2). Port 122 may take the form a standardized port, such as Universal Serial Bus (USB) including USB-C, as a non-limiting example. In order to connect to port 122 when electronic device 120 is positioned in accessory device 100, wall 108b may include an opening 124 aligned with port 122.

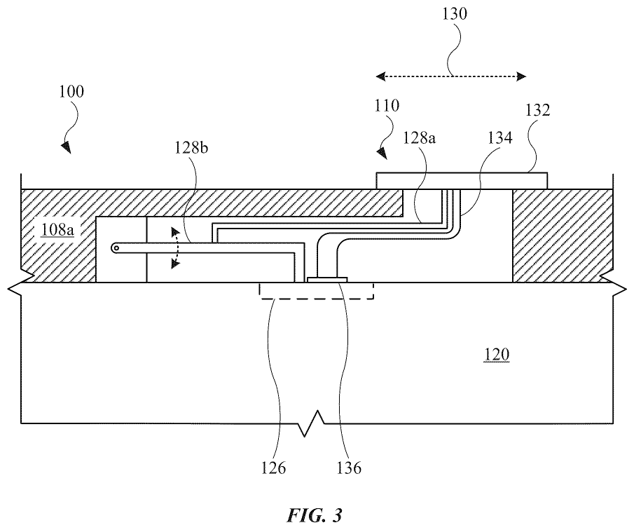

FIG. 3 illustrates a partial cross-sectional view of accessory device 100 and electronic device 120, showing further details of accessory device 100, in accordance with aspects of the present disclosure. Electronic device 120 may include a button 126 (e.g., electronic device button). Button 126 is designed to provide an input to electronic device 120 via actuation (e.g., movement), through a touch input (e.g., capacitive touch), via force sensing (e.g. forces applied below the actuation force, which act as an input signal utilized by software of electronic device 120), or a combination thereof. As shown, button 126 is flush, or at least substantially flush, with respect to a wall (e.g., sidewall) of electronic device 120. Button 110 of the accessory device 100 may be more prominent from wall 108a of the accessory device 100 to enable users to locate button 110 more easily by feel than a flush, or even or sub-flush, button, thus making it easier for users to depress button 126 by way of button 110.

As shown, button 110 is offset with respect to button 126. However, button 110 is designed to provide both actuation and a touch input to button 126. In this regard, accessory device 100 may include a lever 128a and a lever 128b (or arms) positioned in wall 108a. When button 110 is actuated (e.g., depressed), lever 128a may also be actuated, causing movement (e.g., rotational movement) of lever 128b. Based on the movement of lever 128b, lever 128b may actuate button 126, causing generation of an input to electronic device 120. Also, button 110 may be movable along wall 108c in either direction of the two-sided arrow 130. Further, lever 128a may be movable (e.g., with button 110 in either direction of two-sided arrow 130) or may be stationary (e.g., not movable with button 110 in either direction of two-sided arrow 130). In either event, lever 128a may be actuated by button 110 despite movement of button 110 in either direction of two-sided arrow 130.

Also, one or more of levers 128a and 128b may be adjusted to facilitate actuation of button 126 by button 110. For example, the location at which lever 128a contacts lever 128b may be adjusted to lower the activation force required for button 110, when depressed, to actuate button 126 that results in an input generated by button 126. Further, frictional forces of lever 128b may be adjusted to lower the required actuation force. Also, lever 128b may motorized or provided with a spring such that contact by lever 128a, due to actuation of button 110, causes lever 128b to actuate button 126 two or more times. This may simulate a digital single-lens reflex (DSLR) effect when using button 126 to capture images. Also, in one or more implementations, a force may be transferred via at least one of levers 128a and 128b to a force sensor in button 126 of electronic device 110. In this regard, not only actuation but also force sensing that can be communicated from button 110 of accessory device 100 to button 126 of electronic device 120. The force sensor in button 126 of electronic device 120 may be used for user input gestures such as half-press/lightly press and double lightly press, which cause a user interface change in the software of electronic device 120 that controls one or more functions of a camera assembly (not shown in FIG. 3) of electronic device 120.

Additionally, button 110 may include a touch surface 132, such as a touch input surface or touch-sensitive surface. Touch surface 132 may be part of a touch sensor (e.g., capacitive touch sensor) that provides a surface designed to detect a change in capacitance by, for example, a user touching touch surface 132. Accessory device 100 may further include a cable 134 (representative of one or more cables) and a pad 136. When a change in capacitance at touch surface 132 occurs, cable 134 may provide a signal to pad 136 indicating the change in capacitance. When button 126 of electronic device 120 includes a similar touch surface, pad 136 may communicate the change in capacitance to button 126. In this regard, accessory device 100 may communicate inputs in the form of actuation (e.g., mechanical movement) and touch (e.g., capacitive touch) to electronic device 120, with each of the inputs providing a different function. For example, the actuation may cause electronic device 120 to use a camera assembly (not shown in FIG. 3) of electronic device 120 to capture an image(s), while the touch input may open an application (e.g., software application) on electronic device 120 or turn on a light source (e.g., flash) of electronic device 120. Alternatively, cable 134 may be substituted with one or more vias that convey a capacitance change at button 110 and relay the capacitance change to button 126.

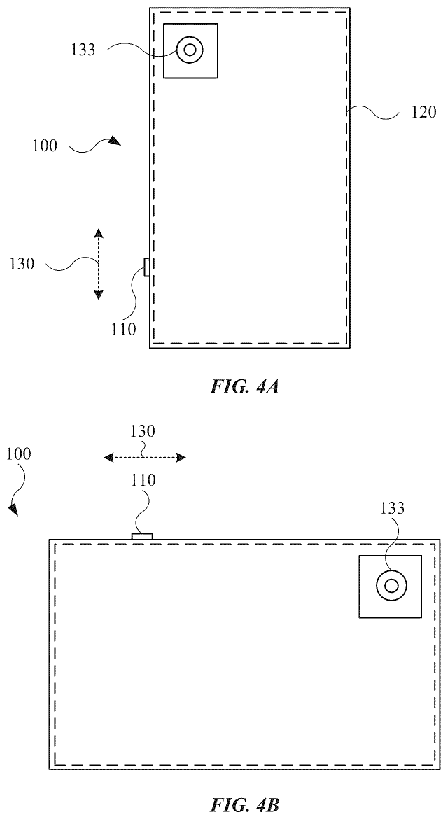

FIG. 4A and FIG. 4B illustrate side views of accessory device 100 and electronic device 120, showing different orientations of accessory device 100 and electronic device 120, in accordance with aspects of the present disclosure. Referring to FIG. 4A, accessory device 100 and electronic device 120 are oriented in a portrait mode. In this regard, a camera assembly 133 (representative of one or more cameras) of electronic device 120 may captures images in a portrait mode resulting in taller and narrower images. Referring to FIG. 4B, accessory device 100 and electronic device 120 are oriented in a landscape mode. In this regard, camera assembly 133 of electronic device 120 may captures images in a landscape mode resulting in wider images.

Based on the functionality of button 110, button 110 is movable in either direction of two-sided arrow 130. Beneficially, users may adjust button 110 to a desired positioned based whether electronic device 120 is oriented in a portrait mode or a landscape mode, or to whatever desired position/angle best accommodates the user's grip. This may include a particular angle for a unique shot and subsequent image capture.

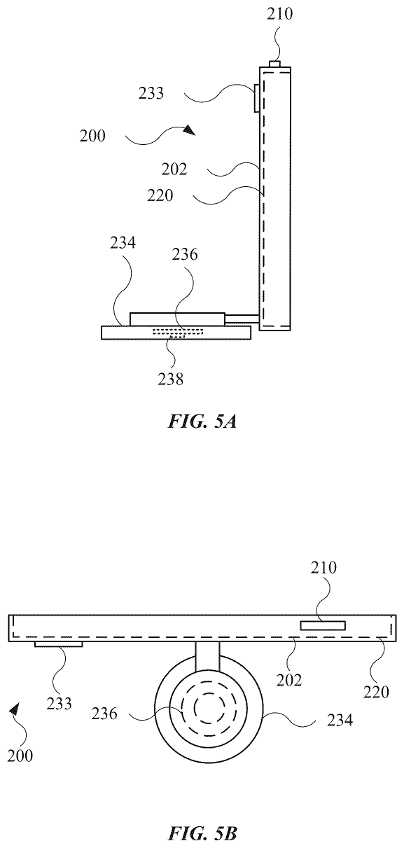

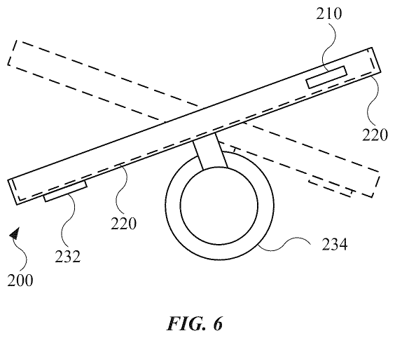

FIG. 5A and FIG. 5B illustrate an alternate embodiment of an accessory device 200, showing accessory device 200 with a stand 234, in accordance with aspects of the present disclosure. As shown, accessory device 200 is carrying an electronic device 220 (shown as dotted lines) within a receptacle 202 of accessory device 200. Additionally, accessory device 200 may include a button 210. Stand 234 may take the form of a movable stand designed to fold in a compact mode or, as shown in FIGS. 5 and 6, extend and provide a base to support the remaining portion (e.g., receptacle 202) of accessory device 200 as well as electronic device 220.

Stand 234 may further include several components. For example, stand 234 may include a component 236. Stand 234 may further include a component 238 (shown in FIG. 5A). In one or more implementations, component 236 takes the form of a spring, such as a rotary spring. Additionally, in one or more implementations, component 238 takes the form of a damper, or damping component. When component 236 takes the form of a spring and is wound to increase potential spring energy and the potential spring energy is subsequently released, the released energy may cause receptacle 202 to rotate, thus causing electronic device 220 and a camera assembly 233 of electronic device 220 to rotate. However, when component 238 takes the form of a damper, the rotational speed that stand 234 provides to receptacle 202 and electronic device 220 may be limited. Alternatively, in one or more implementations, one of components 236 and 238 takes the form of a motor. In this regard, the motor may provide the energy (e.g., work) to rotate receptacle 202 and electronic device 220.

FIG. 6 illustrates an aerial view of accessory device 200 and electronic device 220 shown in FIG. 5A and FIG. 5B, showing exemplary movement of the accessory device 200 and electronic device 220, in accordance with aspects of the present disclosure. As shown, stand 234 (including components 236 and 238 shown in FIG. 5A) may cause receptacle 202 and electronic device 220 rotate, with the final position represented by dotted lines. Moreover, button 210 may be used to initiate an image capturing event in which camera assembly 233 captures images, as well as initiate rotation of receptacle 202 and electronic device 220. Alternatively, electronic device 220 may be set in accordance with a timer to initiate the image capturing event and/or the rotation. When camera assembly 233 captures an image(s) during rotation, camera assembly 233 may produce a panoramic image. Beneficially, the generally steady and constant-speed rotation of electronic device 220 may provide an enhanced panoramic image capturing event.

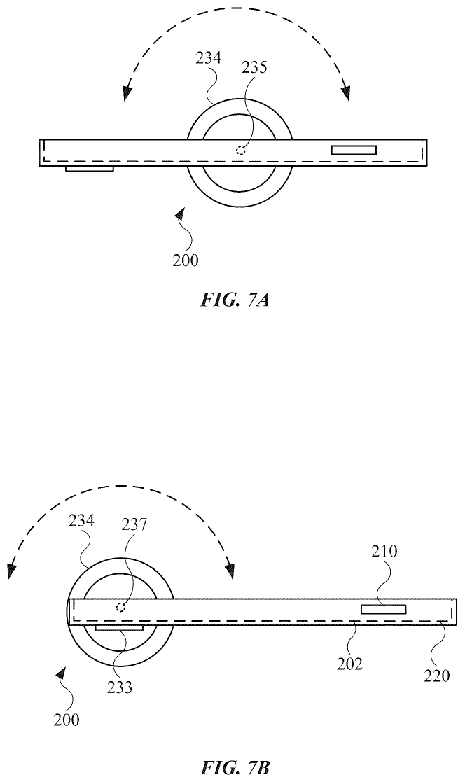

FIG. 7A and FIG. 7B illustrate aerial views of accessory device 200 carrying electronic device 220 for rotational movement of electronic device 220, in accordance with aspects of the present disclosure. Referring to FIG. 7A, accessory device 200 carries electronic device 220 such that electronic device 220 may be rotated, via stand 235 of accessory device 200, about an axis passing through a center point 235 of electronic device 220. As an example, accessory device 200 may include a connector 240 designed to pass through a port (e.g., similar to port 122 shown in FIG. 2). When the port of electronic device 220 is centrally located in electronic device 220, electronic device 220 may be rotated through center point 235.

Referring to FIG. 7B, accessory device 200 carries electronic device 220 such that electronic device 220 may be rotated, via stand 234 of accessory device 200, about an axis passing through a point 237 proximate to camera assembly 233. As a result, an axis near camera assembly 233 is the axis of rotation, and camera assembly 233 is the center of rotation. It should be noted that accessory device 200 may be adjusted in order to adjust the axis of rotation such that any camera of camera assembly 233 may be near an axis of rotation.

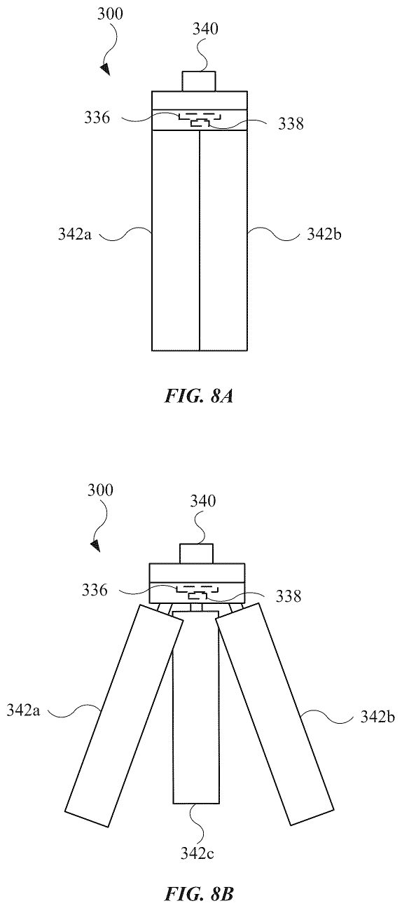

FIGS. 8A and 8B illustrate side views of an alternate embodiment of an accessory device 300 for an electronic device, in accordance with aspects of the present disclosure. Accessory device 300 may be designed to hold or carry an electronic device (e.g., electronic device 120 shown in FIG. 2). In this regard, accessory device 300 may include a plug 340 designed to enter a port of an electronic device (e.g., port 122 of electronic device 120 shown in FIG. 2). Accessory device 300 may further include a component 336 and a component 338. Component 336 and component 338 may include any features described for component 236 and component 238 (shown in FIG. 5), respectively. In this regard, accessory device 300 may provide a rotation force to an electronic device into which plug 340 is positioned, thus causing rotation of the electronic device for panoramic image capturing similar to a manner previously described. Alternatively, in one or more implementations, one of components 336 and 338 takes the form of a motor to provide a similar rotational force.

Referring to FIG. 8A, accessory device 300 includes a leg 342a and a leg 342b, representative of an additional leg of accessory device 300. As shown, legs 342a and 342b adjacent to each other in a closed position. In the closed position, legs 342a and 342b provide a handle for a user to hold accessory device 300. Referring to FIG. 8B, accessory device 300 further includes a leg 342c. As shown, legs 342a, 342b, and 342c are spaced apart from each other in an open position. In the open position, legs 342a, 342b, and 342c provide a stand (e.g., tripod stand) for supporting accessory device 300.

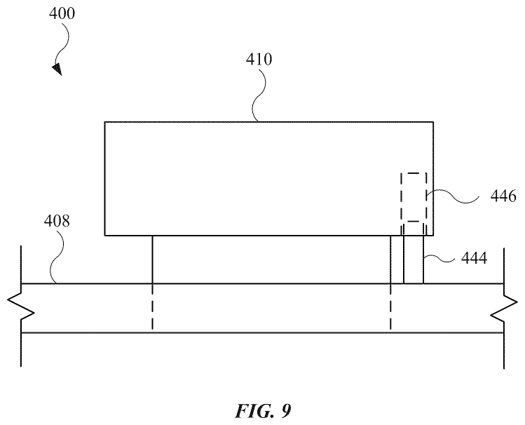

FIGS. 9-14 illustrate accessory devices with button having additional features or modifications. At least some of the features and/or modifications shown and/or described in FIGS. 9-14 may be integrated with prior buttons (e.g., buttons 110 and 210 shown in FIGS. 1 and 5, respectively).

FIG. 9 illustrates a side view of an alternate embodiment of an accessory device 400, showing a button 410 of accessory device capable of being locked and unlocked, in accordance with aspects of the present disclosure. As shown, accessory device 400 includes a wall 408 and button 410 extends from wall 408. Button 410 may include a stop mechanism 444 (representative of one or more stop mechanisms) designed to move relative to button 410. In one or more implementations, stop mechanism 444 takes the form of a post.

In order to actuate a button of an electronic device (not shown in FIG. 9), button 410 is designed to move in a direction toward wall 408. However, as shown, stop mechanism 444 engages wall 408, preventing button 410 from moving toward wall 408 and placing button 410 in a locked position. Thus, button 410 may be characterized as a lockable button. Beneficially, by being locked, button 410 may not be inadvertently actuated, thus preventing inadvertent actuation of an electronic device button. Button 410 may further include a compartment 446 into which stop mechanism 444 may move, thus disengaging from wall 408. When stop mechanism 444 is moved, or at least substantially moved, into compartment 446 and disengaged from wall 408, button 410 transitions to an unlocked position.

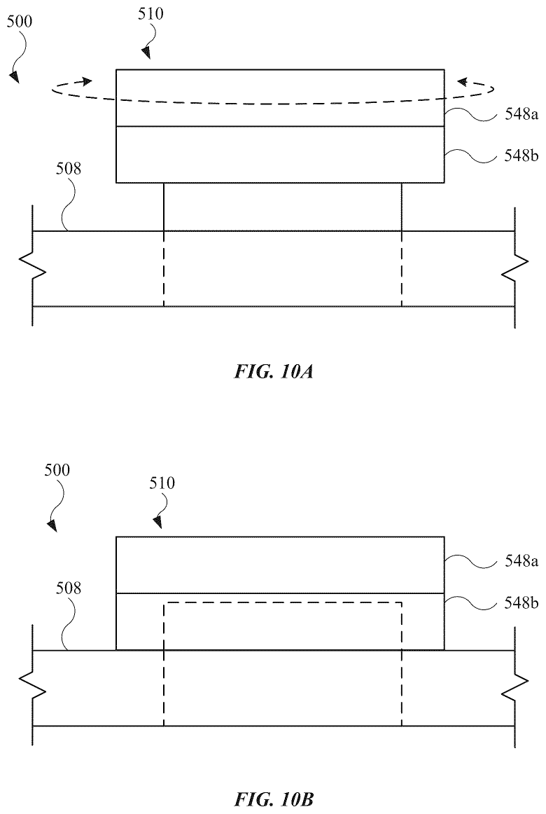

FIG. 10A and FIG. 10B illustrate side views of an alternate embodiment of an accessory device 500, showing exemplary movement of a button 510 of accessory device 500, in accordance with aspects of the present disclosure. Button 510 may be characterized as a lockable button. As shown, accessory device 500 includes a wall 508 and button 510 extends from wall 508. Button 510 may actuated and moved toward wall 508 in order to actuate an electronic device button. Referring to FIG. 10A, button 510 may include a portion 548a and a portion 548b. In one or more implementations, portion 548a is rotatable relative to portion 548b. The rotation of portion 548a may provide an input to an electronic device (not shown). As non-limiting examples, rotation of portion 548a may cause the electronic device to scroll through various applications (e.g., software applications), alter a function of a camera application for capturing images, or scroll through captured images taken by the electronic device. Additionally, portion 548a may include a touch surface (e.g., similar to touch surface 132 shown in FIG. 3) and touch sensor for providing a touch input.

Referring to FIG. 10B, button 510 may be placed in a locked positioned by actuating button toward wall 508 and holding button 510, thus placing button in a locked position. This may include, for example, rotating button 510 to actuate button 510 toward wall 508. Subsequently, button 510 may transition to an unlocked position by again actuating button 510 toward wall 508 and releasing button 510, or conversely, rotating button 510 in the opposite direction such that button 510 moves away from wall 508. It should be noted that FIG. 10A illustrates an exemplary position of button 510 in the unlocked position.

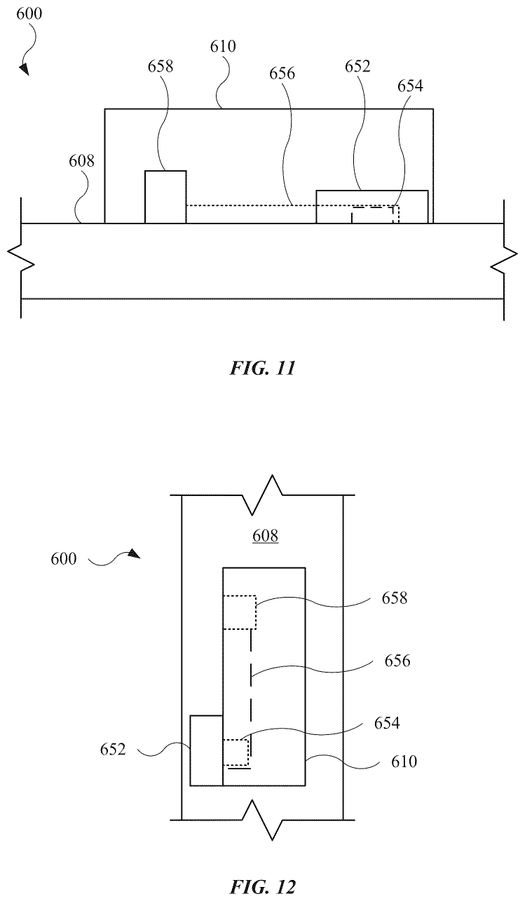

FIG. 11, FIG. 12, FIG. 13, and FIG. 14 illustrate various views of an alternate embodiment of an accessory device 600, showing a button 610 of the accessory device 600 capable of being locked and unlocked by a slider mechanism 652, in accordance with aspects of the present disclosure. Button 610 may be characterized as a lockable button. Referring to FIGS. 11 and 12, accessory device 600 includes a wall 608 and button 610 extends from wall 608. Slider mechanism 652 is designed to control movement of button 610. Slider mechanism 652 may move along wall 608 relative to button 610. As shown, button 610 is in a locked position and is prevented from movement by slider mechanism 652, thus preventing button 610 from actuating an electronic device button. Slider mechanism 652 may include an extension 654. When a user attempt to actuate button 610, extension 654 may prevent actuation based on button 610 engaging extension 654. Also, button 610 may include a slot 656 through which extension 654 may travel. In order to transition from the locked position of button 610 to an unlocked position of button 610, slider mechanism 652 may move relative to button 610 until extension 654 is positioned in a compartment 658, or space, of button 610. This will be shown below.

Referring to FIGS. 13 and 14, button 610 is in the unlocked position. As shown, slider mechanism 652 is moved relative to button 610 such that extension 654 is located in compartment 658 of button 610. As a result, button 610 may be actuated as button 610 will not engage extension 654 based on extension 654 being located in compartment 658.

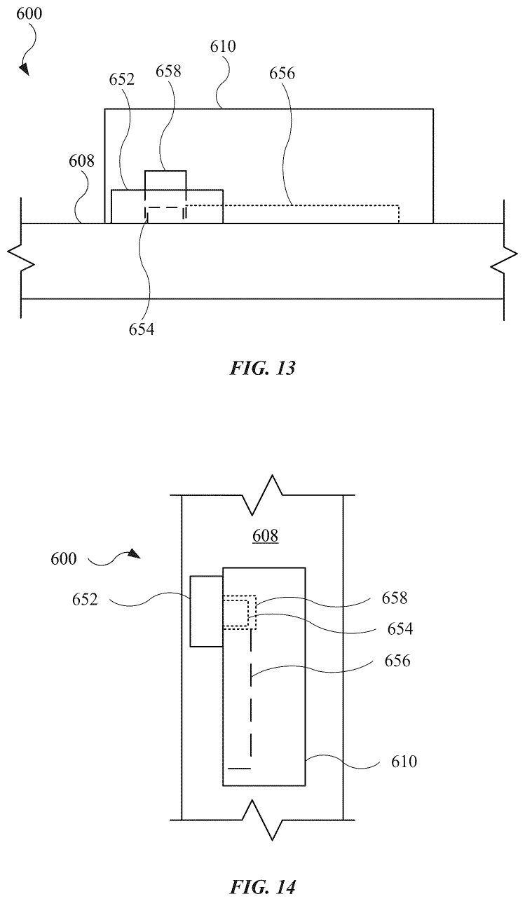

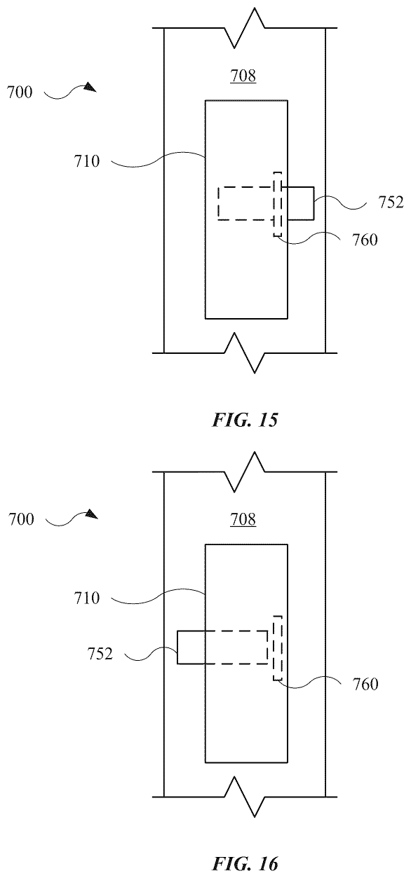

FIGS. 15 and 16 illustrate aerial views of an alternate embodiment of an accessory device 700, showing a button 710 of accessory device 700 capable of being locked and unlocked by form of a slider mechanism 752, in accordance with aspects of the present disclosure. As shown, accessory device 700 includes a wall 708 and button 710 extends from wall 708. Accessory device 700 may further include a locking mechanism 760. In one or more implementations, locking mechanism 760 is embedded, or at least partially embedded, in button 710.

Referring to FIG. 15, button 710 is in the locked position and is prevented from movement by slider mechanism 752. Slider mechanism 752 may engage locking mechanism 760, thus preventing movement of button 710. Referring to FIG. 16, button 710 is in the unlocked position. As shown, slider mechanism 752 is moved such that slider mechanism 752 may no longer engage locking mechanism 760, thus allowing movement of button 710. In this regard, slider mechanism 752 may be moved (e.g., manually moved) by a user to place button 710 in a desired position.

In an alternative embodiment, slider mechanism 752 may be substituted with a fluid substance (e.g., incompressible fluid) embedded in wall 708. The fluid substance may be moved to or away from a structure similar to locking mechanism 760, thus placing button 710 in a locked position or unlocked position, respectively. The fluid substance may be actuated by a user by depressing wall 708 in a location corresponding to the fluid substance.

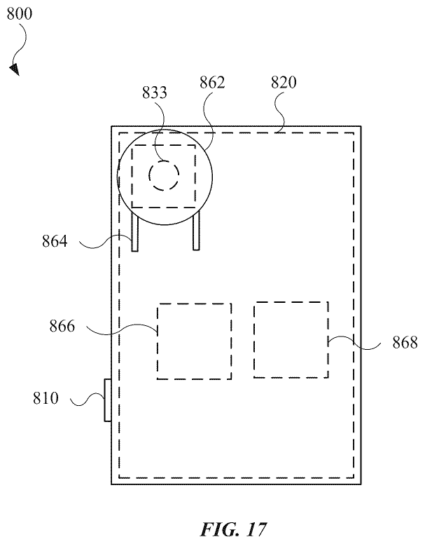

FIG. 17 illustrates a rear view of an alternate embodiment of an accessory device 800, showing various components and features for accessory device 800, in accordance with aspects of the present disclosure. Accessory device 800 may include a button 810, which may include one or more features previously shown and/or described for a button. In this regard, button 810 may include dedicated function/programmable function buttons. For example, button 810 may take the form of a button, which, when pressed, conveys a signal to electronic device (not shown in FIG. 17), and the electronic device may use the signal to, for example, to toggle on or off flash. As shown, an electronic device 820 is positioned in accessory device 800. Electronic device 820 may include a camera assembly 833.

In order to enhance the user experience, accessory device 800 may include additional features. For example, accessory device 800 may include a lens 862 designed to alter the field of view (e.g., zoom) of camera assembly 833 of electronic device 820. In order to hold lens 862, accessory device 800 may include rails 864 that allow lens 862 to slide on or off accessory device 800.

Additionally, accessory device 800 may include a power supply 866 (e.g., battery) used to supply power to electronic device 820 or other component (e.g., motor(s) referenced in regard to FIGS. 5 and 6). Also, accessory device 800 may include memory 868 that provides additional storage for electronic device 820, such as for images captured by camera assembly 833.

Various examples of aspects of the disclosure are described below as clauses for convenience. These are provided as examples, and do not limit the subject technology.

Clause A: An accessory device, including: a receptacle; a sidewall that defines in part the receptacle; and a button extending from the sidewall. In response to an electronic device positioned in the receptacle, the button is i) configured to provide an input to an electronic device button of the electronic device, and ii) offset with respect to the electronic device button.

Clause B: An accessory device, including: a body that defines a receptacle configured to receive an electronic device; a button extending from the body and configured to provide an input to the electronic device; and a stand coupled with the body, wherein in response to the stand in a first position, the stand is configured to rotate the body to a second position different from the first position.

Clause C: An accessory device, including: a receptacle; a sidewall that defines in part the receptacle; and a button extending from the sidewall, wherein in a locked position, the button is prevented from providing an input to an electronic device button of the electronic device.

One or more of the above clauses can include one or more of the features described below. It is noted that any of the following clauses may be combined in any combination with each other, and placed into a respective independent clause, e.g., clause A, B, or C.

Clause 1: further including a lever, wherein in response to actuation of the button, the lever is configured to actuate the electronic device button.

Clause 2: wherein the button includes a touch sensor configured to detect a change in capacitance and provide a signal to the electronic device button in response to the change in capacitance.

Clause 3: wherein the touch sensor includes a capacitive touch sensor.

Clause 4: wherein the button is configured to move along the sidewall.

Clause 5: wherein the button includes a lockable button.

Clause 6: wherein the lockable button includes a stop mechanism that extends from the lockable button, wherein the lockable button is prevented from movement in response to the stop mechanism engaging the sidewall.

Clause 7: wherein the lockable button includes a slider mechanism that extends from the lockable button, wherein the slider mechanism is movable with respect to the lockable button.

Clause 8: wherein the button includes: a first portion; and a second portion, wherein the first portion is rotatable relative to the second portion.

Clause 9: wherein rotation of the first portion is configured to provide an input to the electronic device.

Clause 10: wherein the stand is configured to rotate an electronic device positioned within the receptacle.

Clause 11: wherein the stand includes: a spring configured to provide a rotational force to the body; and a damper coupled with the spring, the damper configured to limit the rotational force.

Clause 12: wherein the button is offset with respect to an electronic device button of the electronic device.

Clause 13: further including a lever, wherein in response to actuation of the button, the lever is configured to actuate the electronic device button.

Clause 14: wherein the button includes a touch sensor configured to detect a change in capacitance and provide a signal to the electronic device button in response to the change in capacitance.

Clause 15: wherein the button includes a stop mechanism that extends from the button, wherein the button is prevented from movement in response to the stop mechanism engaging the button.

Clause 16: wherein: the button includes a slider mechanism that extends the button, and the slider mechanism is movable with respect to the lockable button.

Clause 17: wherein the button includes: a first portion; and a second portion, wherein the first portion is rotatable relative to the second portion.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1. An accessory device, comprising:
a receptacle;
a sidewall that defines in part the receptacle; and
a button extending from the sidewall and in an offset position with respect to the electronic device button, wherein in response to an electronic device positioned in the receptacle, the button is i) configured to provide an input to an electronic device button of the electronic device, and ii) movable with respect to the electronic device button.

2. The accessory device of claim 1, further comprising a lever, wherein in response to actuation of the button, the lever is configured to actuate the electronic device button.

3. The accessory device of claim 1, wherein the button comprises a touch sensor configured to detect a change in capacitance and provide a signal to the electronic device button in response to the change in capacitance.

4. The accessory device of claim 3, wherein the touch sensor comprises a capacitive touch sensor.

5. The accessory device of claim 1, wherein the button is configured to move along the sidewall.

6. The accessory device of claim 1, wherein the button comprises a lockable button.

7. The accessory device of claim 6, wherein the lockable button comprises a stop mechanism that extends from the lockable button, wherein the lockable button is prevented from movement in response to the stop mechanism engaging the sidewall.

8. The accessory device 6, wherein the lockable button comprises a slider mechanism that extends from the lockable button, wherein the slider mechanism is movable with respect to the lockable button.

9. The accessory device of claim 1, wherein the button comprises:
a first portion; and
a second portion, wherein the first portion is rotatable relative to the second portion.

10. The accessory device of claim 9, wherein rotation of the first portion is configured to provide an input to the electronic device.

11. An accessory device, comprising:
a body that defines a receptacle configured to receive an electronic device;
a button extending from the body and configured to provide an input to the electronic device; and
a stand coupled with the body, wherein in response to the stand in a first position, the stand is configured to rotate the body to a second position different from the first position.

12. The accessory device of claim 11, wherein the stand is configured to rotate an electronic device positioned within the receptacle.

13. The accessory device of claim 11, wherein the stand comprises:
a spring configured to provide a rotational force to the body; and
a damper coupled with the spring, the damper configured to limit the rotational force.

14. The accessory device of claim 11, wherein the button is offset with respect to an electronic device button of the electronic device.

15. The accessory device of claim 14, further comprising a lever, wherein in response to actuation of the button, the lever is configured to actuate the electronic device button.

16. The accessory device of claim 15, wherein the button comprises a touch sensor configured to detect a change in capacitance and provide a signal to the electronic device button in response to the change in capacitance.

17. An accessory device, comprising:
a receptacle;
a sidewall that defines in part the receptacle; and
a button extending from the sidewall, wherein in a locked position, the button is prevented from providing an input to an electronic device button of the electronic device.

18. The accessory device of claim 17, wherein the button comprises a stop mechanism that extends from the button, wherein the button is prevented from movement in response to the stop mechanism engaging the button.

19. The accessory device of claim 17, wherein:
the button comprises a slider mechanism that extends the button, and
the slider mechanism is movable with respect to the lockable button.

20. The accessory device of claim 17, wherein the button comprises:
a first portion; and
a second portion, wherein the first portion is rotatable relative to the second portion.
